(19) United States
(12) Patent Application Publication
(10) Pub. No.: US 2020/0187525 A1
(43) Pub. Date: Jun. 18, 2020

(54) METHOD AND SYSTEM FOR THE PRODUCTION OF NON-RUMINANT ANIMAL FEED

(71) Applicant: GRASSA B.V., Venlo (NL)

(72) Inventors: Johan Pieter Marinus SANDERS, Groningen (NL); Sybrandus KOOPMANS, De Punt (NL)

(73) Assignee: GRASSA B.V., Venlo (NL)

(21) Appl. No.: 16/611,257

(22) PCT Filed: Apr. 30, 2018
(86) PCT No.: PCT/NL2018/050280

§ 371 Date: Nov. 6, 2019

(30) Foreign Application Priority Data
May 9, 2017 (NL) 2018873

(51) Int. Cl. A23K 10/30; A23K 20/147; A23K 20/163; A23L 33/125; A23K 50/30; A23N 17/00; A23J 1/00

(52) U.S. Cl. CPC A23K 10/30; A23K 20/147; A23K 20/163; A23V 2002/00; A23K 50/30; A23N 17/00; A23J 1/007; A23L 33/125

(57) ABSTRACT

A method for the production of non-ruminant animal feed from plants and/or plant parts of the family of Poaceae includes the steps of: harvesting plants and/or plant parts; extracting protein and fructan from said plants and/or plant parts; separating protein for feeding non-ruminant animals; and separating fructan for feeding non-ruminant animals. The fructan stimulates bacterial growth and protein production in the large intestine of the non-ruminant animals and reduces the concentration of amino acid catabolites in the large intestine.

The present invention relates to a method for the production of non-ruminant animal feed from plants and/or plant parts, preferably of the family of Poaceae, to produce animal feed for non-ruminant animals.

In practice, plants are used for animal feed. For example, cereal plants are used as feed for pigs and poultry. More specifically, animal feed often originates as a side stream from an industrial production method for vegetable oil, starch, ethanol or sugar. Especially a side stream with an amount of protein that can be used as animal feed, such as rapeseed meal, sunflower meal, soy meal and dried distillers grain. However also whole plants are used as animal feed, such as maize, grain, etc.

In practice, it is also known to feed grass to ruminant animals such as cows. It is known that protein originating from grass is of a relatively high quality and is widely available. However, costs associated with providing grass protein to non-ruminant animals, such as pigs and poultry are relatively costly as compared to the aforementioned side streams from an industrial production method.

Ruminant animals are able to acquire nutrients from plant-based food by fermenting it in a specialized four compartment stomach prior to digestion and through the microflora present in the digestive pathway, wherein the fermentation occurs in a specialized rumen stomach part of the four stomach system. The process requires the fermented food to be regurgitated and chewed again (also known as rechewing) to further break down plant matter and stimulate digestion. Non-ruminant animals do not have this specialized four-compartment stomach.

One of the problems with animal feed origination from the aforementioned side streams is that when feeding protein sources to the animals, and especially non-ruminant animals, is that considerable parts of the protein is not digested in the small intestine. Therefore the amino acids, of which these proteins are comprised of, are digested in the large intestine and often toxic compounds concentrate in the large intestine and cannot be absorbed in the ileum at the end of the small intestine. Consequently, these amino acids are available at the ileum in a rather restrictive level/low concentration and the catabolites of several amino acids accumulating in the large intestine cause adverse reactions to the animal.

The ileum comprises an extremely large surface area for the absorption of products of digestion, such as amino acids. Cells in the lining of the ileum secrete enzymes such as protease and carbohydrase that are responsible for the final stages of protein and carbohydrate digestion. Large amounts of amino acid catabolites accumulating in the large intestine subsequently cause the forming of poisonous mono- and diamines, such as putrescine, cadaverine, methyl amine but also indols and cresols that are known as uncouplers of the proton motive force at the cellular membrane level and are therefore harmful for the animals and may have an adverse effect on animal growth.

The present invention has for its object to obviate or at least reduce the above stated problems in the production and application of animal feed and to provide a feed that can be manufactured cost efficient and/or with a higher quality and a feed that is suitable for feeding non-ruminant animals.

For this purpose, the present invention relates to a method for the production of non-ruminant animal feed from plants and/or plant parts, the method comprises the steps of

harvesting plants and/or plant parts;

extracting a mixture of protein and fructan from said plants and/or plant parts:

separating protein from said mixture for feeding non-ruminant animals; and/or

separating fructan from said mixture for feeding non-ruminant animals,

wherein more than 20 wt. % of the dry solid content of the plants and/or plant parts is extracted as protein and/or fructan,

wherein the fructan stimulates bacterial growth and protein production in the large intestine of said non-ruminant animals and reduces the concentration of amino acid catabolites in the large intestine. The advantage of separating the protein of the fructans, is that you are able to select an optimum ratio between these two components in the final animal feed product. This is very useful because in the plant, not always the optimal ratio between these two components is present that is suitable for animal feed. Moreover, it is also useful when taking account of the remaining ingredients from which the feed is constituted, apart from the grass protein. Furthermore, the amount of fructan (or fructooligosaccharides) required to reduce the concentration of amino acid catabolites in the large intestine depends on the amount of amino acids not absorbed at the ileal level.

According to another embodiment the present invention relates to the method, wherein the plants and/or plant parts are of the family of Poaceae. This of Poaceae is also referred to as Gramineae. This family includes diverse types of plants, including grass. This family of grasses includes grasses of natural grass land, grass from agricultural grass lands, and cereal grasses. In a presently preferred embodiment the method is applied to grass that originates from agricultural grass lands. Other plant material that may be used in the method of present invention and that comprise high fructan content are alfalfa, agave, (Jerusalem) artichokes, chicory, asparagus, leeks, garlic, onions and wheat.

Preferably, the non-ruminant animals are selected from the group consisting of poultry, pigs, fish, dogs, cats, preferably poultry or pigs. This method for extracting protein and fructan from grass plants, specifically agricultural grass lands, enables providing animal feed to these animals from (agricultural) lands that are often close to the farms and enables these animals to digest grass protein. This reduces transport of feed and contributes to a more sustainable process. The short distance is important to reduce time and costs between mowing and processing of the grass. Short distance, short cycle process is also important to return the minerals from the grass which are not necessary for the feed, back to agricultural fields. This all contributes to the sustainability of the process.

The protein originating from these plants, specifically the grasses, is of high quality in view of the amino acid composition. The proteins can be dried in order to store this valuable product over time. This storage time can be at least one month to 6 months or even at least one year. This enables shipping part of the produced protein to other farms or compound feed industry. In addition these storage times enables agricultural companies to overcome periods in a year that no grass can be harvested.

When processing the plants (especially plant cells or plant parts), protein can be extracted, including carbohydrates. It was found that these carbohydrate as a polymer of fructose, or as an oligomer of fructose can be isolated. These carbohydrates substantially comprise fructans and more specifically Fructooligosaccharides (FOS). These fructans are not digested in the small intestine and are mainly digested in the large intestine of a non-ruminant animal, such as poultry or pigs. To achieve this, it is preferred in the method of present invention to quickly process the grasses after harvest (short distances from field to machine) without long residence times in the process and/or to apply a heating step as to avoid enzymatic breakdown of the polyfructose.

The extraction of fructan from the plants, preferably the FOS, enables the provision of fructan for feeding non-ruminant animals. Surprisingly, the fructan, more specifically the FOS, is capable of stimulating bacterial growth and/or protein synthesis in the large intestine to reduce the concentration of the poisonous compounds formed from amino acids. It was shown that the fructans, more specifically the FOS, are capable of reaching the large intestine of non-ruminant animals when being provided as animal feed to achieve the aforementioned reduction of the poisonous compounds. It was shown that using this feed provides an advantageous effect on animal growth and health, and in addition contributes to reducing the stress level of pigs and mortality of piglets, for example.

It will be understood that the fructan, and specifically the FOS, provides energy for bacterial growth and the production of proteins by the bacteria present in the large intestine, and FOS is capable of passing through the small intestine such that the energy can be used in the large intestine.

In a presently preferred embodiment of the invention more than 25 wt. % of the dry solid content of the plants and/or plant parts, preferably grasses from agricultural grass lands, is extracted as protein and fructan, more preferably more than 30 wt. %, and most preferably more than 35 wt. %, such as about 60 wt. %.

Extracting protein and fructan in a significant amount enables a cost effective production of animal feed, more specifically this includes producing non-ruminant animal feed. A substantial part of the remaining material may be used for cow feed, for example, because ruminants benefit much more from the remaining material than mono gastric animals since these remaining materials consist of high levels of so called “resistant protein”, that are not degraded in the rumen of the cows. Also this fraction is attractive to horses. This cost effectiveness is also achieved because the proteins which are available for non-ruminants have such a high value due to their amino acid composition. The processing of grass according to the present invention leads to an increased utilization of grass and/or grass components, as roughage for dairy cows as well as non-ruminant animal, and thereby contribute to increasing the sustainability. This remaining material is baled in plastic foil to exclude air so that this material can be stored for longer periods to overcome periods in a year that no grass can be harvested or to transport it to other farms.

The feed combination of the separated fructan and protein that can be extracted by an extraction process of grasses provides animal feed with high quality protein and fructan that is capable of stimulating bacteria growth and/or protein synthesis in the large intestine, thereby reducing the concentration of toxic compounds that are formed from these amino acids present in the large intestine.

It is shown that the fructans, specifically the FOS, is available in such an amount that the feed combination may comprise additional protein from other protein sources. Also for these additional proteins the adverse effects can be neutralized with the FOS originating from the grass plants. This renders the use of the FOS even more effective.

In addition to providing additional protein to the animal feed, or in combination therewith, an amount of fructan extracted from the plants can be separated and further treated to produce nutrition supplement, for humans.

The provision of FOS provides relevant nutrients. Especially a combination of FOS, XOS (Xylose oligosaccharides) and GOS (Galacto oligosaccharide) provides an effective nutrient basis.

In a presently preferred embodiment of the invention the extracting step is performed within a time period of 12 hours from the harvesting step, preferably within a time period of 8 hours, and most preferably within a time period of 6 hours.

Experiments have shown that performing the extraction process relatively directly after the actual harvesting of the plants, such as grass of the agricultural grass lands, results in a high quality of protein and fructan, and a relatively high level of extracted protein and fructan in the product.

Preferably, the extraction step is performed at or close to a harvesting location or the extraction step is performed at or close to a feeding location of said non-ruminant animals. This significantly contributes to the reduction of a time period between harvesting and extraction step in the method of the present invention. Furthermore, this significantly reduces transport costs for transferring harvested material to a treatment plant. This enables cost effective production of animal feed.

According to a second aspect, the present invention relates to an animal feed for non-ruminant animals, wherein the animal feed is comprised of fructan obtained from plants and/or plant parts of the family of Poaceae and wherein the fructan stimulates bacterial growth and protein production in the large intestine of said non-ruminant animals and reduces the concentration of amino acid catabolites compounds in the large intestine of said non-ruminant animals.

Catabolites and free amino acid compounds that are not converted in protein e.g. by the microflora in the large intestine, accumulate over time in the large intestine and form poisonous compounds, such as ammonia, amines, indols and cresols, that are harmful for the animals and may have an adverse effect on animal growth and wellbeing.

According to a preferred embodiment, the present invention relates to the animal feed that is obtained according to the method of present invention.

According to another preferred embodiment, the present invention relates to the animal feed, wherein the animal feed is dried in order to store said feed for at least one month, preferably at least six months, more preferably at least one year. More specifically, the proteins or FOS can be dried and sealed into plastic foil to exclude air in order to store this valuable product over time. This enables shipping of the product to other compound feed industries but may also serve as storage product to overcome periods in the year wherein no grass could be harvested.

In a presently preferred embodiment the extraction step is performed with a mobile extraction system. This further contributes to performing the extracting step at or close to the harvesting location. Such mobile extraction system may use a trailer or truck that comprises an extraction device capable of performing the extraction step. A mobile system enables flexible operation. In fact, transporting the mobile system is more efficient as compared to the conventional transport of harvested material, and after processing transport of the resulting products.

A further advantage of the method according to the present invention when performing the extracting step at or close to the harvesting location is that minerals and compounds originating from the harvested plants can be effectively returned to the harvesting location without the need to concentrate before returning. This improves the sustainability of the harvesting operation and as a further effect may reduce the need for dosing additional fertilizer. This contributes to a more sustainable and cost effective operation.

The present invention further relates to an extraction device for extracting protein or fructan from plants, wherein the system is configured for performing the method in one of the embodiments of the invention.

Such extraction device provides the same effects and advantages as described in relation to the method. In one of the presently preferred embodiments the extraction device is configured for small scale extraction. This further contributes to extracting the plants at or close to the harvest location.

The present invention further also relates to a mobile extraction system comprising an aforementioned extraction device. Preferably the mobile extraction system of present invention comprises a trailer or truck.

Such mobile extraction system provides the same effects and advantages as described in relation to the method and extraction device.

In a presently preferred embodiment the mobile extraction system comprises a trailer or truck. This enables performing an effective extraction step at or close to the harvesting location where after the mobile extraction system moves to the next harvesting location.

Further advantages, features and details of the present invention are elucidated on the basis of preferred embodiments thereof, wherein reference is made to the accompanying drawings, and examples in which:

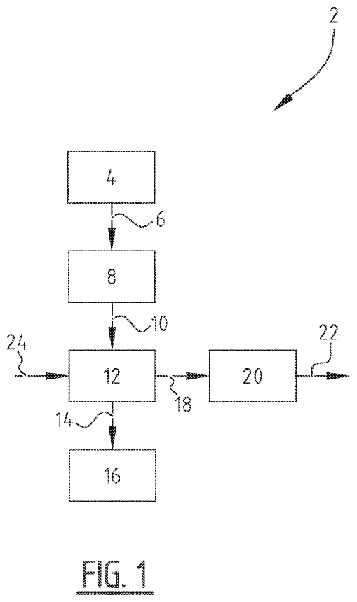

FIG. 1 schematically shows a preferred embodiment of the method according to the invention; and

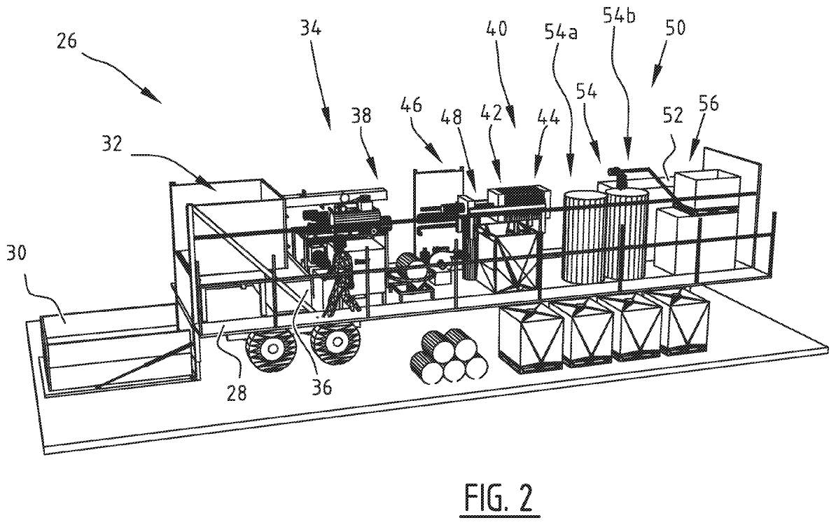

FIG. 2 shows an embodiment of a mobile extracting system of the invention.

Extraction method 2 (FIG. 1) starts with harvesting step 4. Harvesting step 4 provides harvested plant material 6 to extraction step 8.

In extraction step 8 protein and/or fructan is extracted from the plants. The separated protein and/or fructan 10 is provided to preparation step 12.

In preparation step 12 fructan and protein is combined in the desired amounts to produce animal feed 14. In feeding step 16 feed 14 is preferably provided to non-ruminant animals such as pig and poultry.

Optionally, a fraction 18 of the separated FOS is provided to treatment step 20 that treats the FOS and produces a further product 22, for example a nutrition supplement for humans. Also optionally, in preparation step 12 an additional amount of protein 24 from a further protein source is added to the separated protein and/or fructan 10 from extraction step 8.

Mobile system 26 (FIG. 2) comprises trailer 28. Harvested material is provided to trailer 28 with the aid of lift 30. In the illustrated embodiment lift 30 is also capable of measuring the weight of the harvested material. In trailer 28 the supplied harvested material enters supply system 32 as part of pretreatment subsystem to process the harvested leaf material 34 to open the plant cells/cell walls. Pretreatment subsystem 34 further comprises washing basin 36. Acidification tank 38 is part of extraction subsystem 40 that extracts and separates protein and fructan.

Precipitation tank 54a in subsystem 50 is used for the coagulation of phosphates using Ca(OH)₂. Tank 54b serves as a buffer for the deproteinized and conserved juice.

Subsystem 40 comprises filter 42, steam injector 48 and protein drier 44. Freshly pressed juice is heated using steam injector 48 and then the heat-coagulated protein is filtered off in filter 42. The dewatered protein is led to the protein drier 44 which uses heat from the cooling system of the generator to further dry the protein concentrate to 85% dry matter. Subsystem 40 further comprises a buffer tank 46 and additive tank 48.

It will be understood that trailer 28 is further provided with airlets and outlets and generator and fuel tank or other energy source.

Mobile system 26 can be transported to a desired harvesting location. This enables a relatively fast treatment of the harvested material. This also enables returning minerals from the process to the harvesting location.

In an experiment grass leaves (10 kg) were macerated and pressed to obtain a green juice having approximately 8% w/w solids. The temperature during the maceration and pressing did not exceed 35° C. Sodium bisulphite (0.5% w/w) was added to the juice. Then, the green juice was heated to 80° C. using steam injection. The coagulated proteins were filtered off and dried at a temperature of 70° C. After drying, 320 grams of protein concentrate was obtained. The protein concentration was 45% w/w. The dry proteins were used as the protein component in chicken feed.

The filtrate was treated with 3 g/l Ca(OH)₂. The resulting precipitation was allowed to settle, and the supernatant was removed. About 4% of the fluid volume was precipitation. The phosphate concentration in the supernatant was reduced by 90%. The solids were used as a fertilizer.

The supernatant was concentrated using a cascade of ultra- and nanofiltration. The ultrafiltration membrane used in this experiment was a Pentair/X-flow F4385 and the nanofiltration membrane was a Trisep XN-45. The combined retentates of ultrafiltration and nano filtration has a dry weight concentration of 15% w/w. A concentrate having 15% w/w solids consisting of fructose, glucose and FOS. Depending on the moment of cutting and the grass cultivar, the polyfructose content is about 35% w/w of the total carbohydrate content. The permeate after nanofiltration mainly comprises amino acids and minerals and has a dry matter content of 2% w/w and was used as a liquid fertilizer.

Grass juice was used as a component in a liquid feed formula for pigs. Because of the polyfructose ingestion, the pigs showed a better health and a lower pig mortality was observed (30% reduction). Therefore, this experiment showed advantageous effects of the method according to the present invention.

Cooling is not necessary for precipitation. However, performing a cooling step may contribute in the preservation of the proteins.

Furthermore, experiments showed that the method for the production of non-ruminant animal feed from plants and/or plant parts obviates the need for the use of hazardous additives and/or obviates the need for the use of large amounts of additives which are hard to recover.

The present invention will be further detailed in the following examples wherein:

### EXAMPLE 1

4 tonnes of fresh, late season grass harvested not longer than 4 hours before processing was weighted, washed and grinded to open the grass leaf cells. In this process, the temperature of the grass did not exceed 35° C. The pulp was pressed and the fibrous material was discarded. The resulting juice was heated to 85° C. by steam injection in order to deactivate the enzymes and coagulate the proteins present in the juice. The feed composition of the resulting juice was analysed to contain 20 g/l protein and 25 g/carbohydrates of which 35% w/w fructose oligo saccharides (FOS). The weight average degree of polymerisation of the FOS was determined to be around 15 by HPAEC (high performance anionic exchange chromatography).

### EXAMPLE 2

5000 piglets were fed with liquid feed during 35 days (Table 1). Half of the piglets were fed using feed in which all of the soy protein was substituted by grass juice. This grass juice was isolated as described in Example 1. The protein content of both feeds was 17% w/w.

TABLE 1

| | | Initial | | Final body | Damaged |
|---|---|---|---|---|---|
| | Number | Body | Feed | weight | tail (after |
| | of days | weight (kg) | conversion | (kg) | 35 days), % |
| Control feed | 35 | 5.9 | 2.71 | 19.8 | 8.2% |
| Feed with | 35 | 6.0 | 2.73 | 20.0 | 3.3% |
| grass juice | | | | | |

The group being fed on the grass juice mix showed a better health, especially regarding the amount of diarrhoea and healthy, uninfected tails. The following feed compositions were used:

TABLE 2
Grass mixture

| Grass-juice mixture | DS % | Total, kg |
|---|---|---|
| Premix barley/wheat | 34.78 | 169.1 |
| DA-meal | 14.00 | 63.57 |
| grass-juice | 6.00 | 74.17 |
| visprovet | 33.00 | 13.08 |
| water | 0.00 | 37.91 |
| TWM speen 13% Van Gorp | 96.30 | 13.00 |

TABLE 3
Soy mixture

| Standard mixture | DS % | Total, kg |
|---|---|---|
| Pre mix barley/wheat | 34.78 | 114.51 |
| DA-meal | 13.00 | 54.46 |
| visprovet | 45.00 | 9.67 |
| water | 0.00 | 148.39 |
| barley grinded | 87.10 | 13.31 |
| TWM speen 12% Van Gorp | 94.82 | 12.00 |
| wheat grinded | 86.80 | 11.36 |
| Soya 49/3 grintled | 87.30 | 5.05 |

The examples show an effective production of non-ruminant animal feed from plants and/or plant parts, preferably of the family of Poaceae, to produce animal feed for non-ruminant animals. More specifically, the examples show that more than 20 wt. % of the dry solid content of the plants and/or plant parts is extracted as protein and/or fructan, wherein the fructan stimulates bacterial growth and protein production in the large intestine of said non-ruminant animals and reduces the concentration of amino acid catabolites in the large intestine.

The present invention is by no means limited to the above described preferred embodiment thereof. The rights sought are defined by the following claims within the scope of which many modifications can be envisaged.

1. A method for the production of non-ruminant animal feed from plants and/or plant parts, the method comprises the steps of
harvesting plants and/or plant parts;
extracting a mixture of protein and fructan from said plants and/or plant parts:
separating protein from said mixture for feeding non-ruminant animals; and/or
separating fructan from said mixture for feeding non-ruminant animals,
wherein more than 20 wt. % of the dry solid content of the plants and/or plant parts is extracted as protein and/or fructan,
wherein the fructan stimulates bacterial growth and protein production in the large intestine of said non-ruminant animals and reduces the concentration of amino acid catabolites in the large intestine.

2. The method according to claim 1, wherein the plants and/or plant parts are of the family of Poaceae.

3. The method according to claim 1, wherein the fructan comprises fructooligosaccharides (FOS).

4. The method according to claim 1, wherein the plants are from agricultural grass lands.

5. The method according to claim 1, wherein more than 25 wt. % of the dry solid content of the plants and/or plant parts is extracted as protein and fructan.

6. The method according to claim 1, further comprising the step of feeding animals with a feed combination of the separated fructan and/or protein.

7. The method according to claim 6, wherein the feed combination further comprises protein from other sources.

8. The method according to claim 6, wherein a part of the separated fructan is treated to produce nutrition supplements for humans.

9. The method according to claim 1, wherein the non-ruminant animals are selected from the group consisting of poultry, pigs, fish, dogs, and cats.

10. The method according to claim 1, wherein the extraction step is performed within a time period of 12 hours from the harvesting step.

11. The method according to claim 1, wherein the extraction step is performed at or close to a harvesting location.

12. The method according to claim 1, wherein the extraction step is performed at or close to a feeding location of said non-ruminant animals.

13. The method according to claim 11, wherein the extracting step is performed with a mobile extraction system without the need to concentrate minerals and other components required for soil fertility, before returning these components to the harvesting location.

14. An animal feed for non-ruminant animals, wherein the animal feed is comprised of fructan obtained from plants and/or plant parts of the family of Poaceae and wherein the fructan stimulates bacterial growth and protein production in the large intestine of said non-ruminant animals and reduces the concentration of amino acid catabolites in the large intestine.

15. The animal feed according to claim 14, wherein the animal feed is obtained according to a method comprising the steps of:
harvesting plants and/or plant parts;
extracting a mixture of protein and fructan from said plants and/or plant parts:
separating protein from said mixture for feeding non-ruminant animals; and/or
separating fructan from said mixture for feeding non-ruminant animals,
wherein more than 20 wt. % of the dry solid content of the plants and/or plant parts is extracted as protein and/or fructan,
wherein the fructan stimulates bacterial growth and protein production in the large intestine of said non-ruminant animals and reduces the concentration of amino acid catabolites in the large intestine.

16. The animal feed according to claim 14, wherein the animal feed is dried in order to store said feed for at least one month.

17. An extraction device for extracting protein and fructan from plants, the system configured for performing the method according to claim 1.

18. A mobile extraction system comprising an extracting device according to claim 17.

19. The method according to claim 1, wherein the plants and/or plant parts are of the family of Poaceae, wherein the fructan comprises fructooligosaccharides (FOS), and wherein the extraction step is performed at or close to a harvesting location.

20. The method according to claim 1, further comprising the step of feeding animals with a feed combination of the separated fructan and/or protein, wherein the plants and/or plant parts are of the family of Poaceae, wherein the fructan comprises fructooligosaccharides (FOS), wherein the extraction step is performed at or close to a harvesting location, and wherein the animal feed is comprised of fructan obtained from plants and/or plant parts of the family of Poaceae and wherein the fructan stimulates bacterial growth and protein production in the large intestine of said non-ruminant animals and reduces the concentration of amino acid catabolites in the large intestine.
